(19) United States
(12) Patent Application Publication
(10) Pub. No.: US 2005/0237406 A1
(43) Pub. Date: Oct. 27, 2005

(54) CMOS image sensor for processing analog signal at high speed

(76) Inventors: Song-Yi Kim, Chungcheongbuk-do (KR); Chang-Min Bae, Chungcheongbuk-do (KR); Nam-Ryeol Kim, Chungcheongbuk-do (KR); Hack-Soo Oh, Chungcheongbuk-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/096,926

(22) Filed: Mar. 30, 2005

(30) Foreign Application Priority Data
Apr. 21, 2004 (KR) 2004-27596
Dec. 30, 2004 (KR) 2004-116655

(51) Int. Cl. H04N 5/217

(52) U.S. Cl. 348/308

(57) ABSTRACT

A CMOS image sensor is provided. In the CMOS image sensor, a pixel array has a plurality of first color pixels, a plurality of second color pixels and a plurality of third color pixels, which are arranged in matrix form. A CDS (correlated double sampling) part has CDS circuits to receive output signals of the pixels, one CDS circuit per column being provided. A plurality of analog data buses receive divided output signal of the CDS circuits. An ASP (analog signal processor) is connected to the plurality of analog data buses.

### FIELD OF THE INVENTION

The present invention relates to a CMOS image sensor; and, more particularly, to a CMOS image sensor for processing an analog signal at high speed and a signal processing method therein.

### DESCRIPTION OF RELATED ART

An image sensor is an apparatus to convert an optical image into an electrical signal. Such an image sensor is largely classified into a complementary metal oxide semiconductor (CMOS) image sensor and a charge coupled device (CCD).

In the case of the CCD, individual MOS capacitors are disposed very close to one another and charge carriers are stored in and transferred to the capacitors. Meanwhile, in the case of the CMOS image sensor, a pixel array is constructed using a CMOS integrated circuit technology and output data are detected in sequence through a switching operation. Since the CMOS image sensor has an advantage of low power consumption, it is widely used in a personal communication system, such as a hand-held phone.

FIG. 1 is a diagram of a conventional CMOS image sensor. In FIG. 1, a processing of image data (analog signals) from pixels is shown.

Referring to FIG. 1, the conventional CMOS image sensor includes a pixel array 11 where red (R), green (G) and blue (B) pixels are arranged in an M N matrix. A correlated double sampling (CDS) part 12 including CDS circuits is provided at a lower side of the pixel array 11. The CDS circuit is provided at each column. An analog signal processor (ASP) 13 is provided at a right side of the pixel array 11 and processes the analog signals outputted from the CDS part 12.

The CDS circuit samples a reset signal and a data signal from each pixel and applies the sampled signals on an analog data bus. Then, the ASP 13 calculates a difference value between the reset signal and the data signal and amplifies it. Accordingly, a pure pixel data of an actual object can be obtained.

In reading a pixel data, the pixels arranged along one row of the pixel array 11 are transferred to the respective CDS circuits of the CDS part 12 at once and at the same time (at the same clock). Under the control of a column driver 14, the outputs of the CDS circuits are sequentially transferred to the ASP 13 and then processed therein.

As described above, according to the conventional CMOS image sensor, when one row is selected, the pixel signals (reset signal and data signal) of the selected row are stored in the corresponding CDS circuit. Then, the signals of the respective CDS circuits are sequentially transferred to the ASP by the column driver.

Meanwhile, if millions of pixels are arranged, the number of pixels arranged in a row direction increases and therefore the number of the CDS circuits must increase as much. Also, the analog data bus is commonly connected to a large number of CDS circuits. Thus, a load capacitance of the analog data bus also increases.

For these reasons, the conventional system cannot achieve high-speed operation. In order for the high-speed operation, the functional block (especially, ASP) needs to be improved to obtain a desired signal processing performance. Also, if a high-speed system is designed, a timing margin for stabilizing a signal value within a settling time is small. Therefore, the reliability and productivity of the devices are degraded.

### SUMMARY OF THE INVENTION

It is, therefore, an object of the present invention to provide a CMOS image sensor, in which a high-speed operation can be achieved even though a low-speed system (for example, ASP) is used.

It is another object of the present invention to provide a CMOS image sensor, in which while the signals are processed through the multi-paths, the signals of the same pixels of the pixel array are processed through the same path, so that the offset between the same pixels can be minimized and the picture quality can be improved.

In an aspect of the present invention, there is provided a CMOS image sensor, comprising: a pixel array having a plurality of first color pixels, a plurality of second color pixels and a plurality of third color pixels, which are arranged in matrix form; a CDS (correlated double sampling) part having CDS circuits to receive output signals of the pixels, one CDS circuit per column being provided; a plurality of analog data buses for receiving divided output signal of the CDS circuits; and an ASP (analog signal processor) connected to the plurality of analog data buses.

In another aspect of the present invention, there is provided a CMOS image sensor, comprising: a pixel array having a plurality of R pixels, a plurality of G pixels and a plurality of B pixels that are arranged in matrix form; a first analog signal processing path arranged in one side of the pixel array to process analog signals outputted from the G pixels of the pixel array; and a second analog signal processing path arranged in the other side of the pixel array to process analog signals outputted from the B pixels or the R pixels of the pixel array.

In a further another aspect of the present invention, there is provided a CMOS image sensor, comprising: a pixel array having a plurality of first color pixels, a plurality of second color pixels and a plurality of third color pixels, which are arranged in matrix form; a lower CDS (correlated double sampling) part arranged in a lower side of the pixel array to receive output signals of the pixels, one CDS circuit per column being provided in the lower CDS part; an upper CDS part arranged in an upper side of the pixel array to receive output signals of the pixels, one CDS circuit per column being provided in the upper CDS part; a plurality of lower analog data buses for receiving divided output signal of the CDS circuits of the lower CDS part; a plurality of upper analog data buses for receiving divided output signal of the CDS circuits of the upper CDS part; a lower ASP (analog signal processor) connected to the plurality of lower analog data buses; and an upper ASP connected to the plurality of upper analog data buses.

### BRIEF DESCRIPTION OF THE DRAWINGS

The above and other objects and features of the instant invention will become apparent from the following description of preferred embodiments taken in conjunction with the accompanying drawings, in which:

FIG. 1 is a diagram of a conventional CMOS image sensor, showing an analog signal processing path;

FIGS. 2 to 6 are diagrams of a CMOS image sensor in accordance with embodiments of the present invention, showing an analog signal processing path; and

FIG. 7 is a diagram illustrating a decoding scheme in the analog signal processing path structure of FIG. 5 in accordance with a first embodiment of the present invention;

FIGS. 8A to 8C are timing diagram illustrating an operation of a CMOS image sensor shown in FIG. 7; and

FIG. 9 is a diagram illustrating a decoding scheme in the analog signal processing path structure of FIG. 5 in accordance with a second embodiment of the present invention.

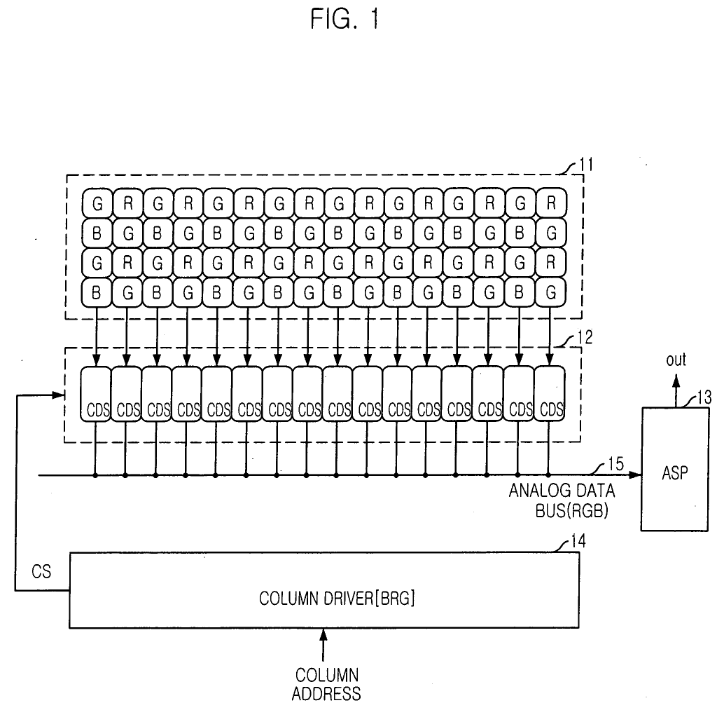

### DETAILED DESCRIPTION OF THE INVENTION

Hereinafter, the present invention will be described in detail with reference to the accompanying drawings.

First Embodiment

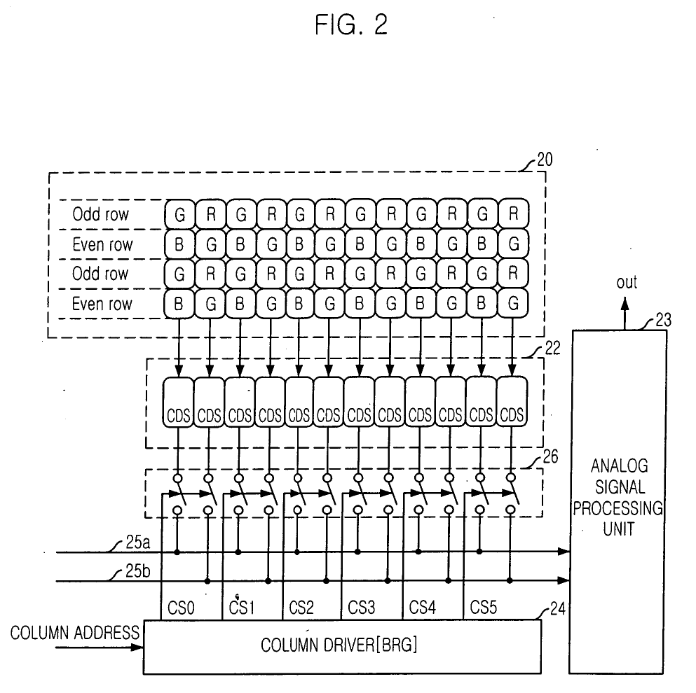

FIG. 2 is a diagram of a CMOS image sensor in accordance with a first embodiment of the present invention. Image data (analog signals) obtained from pixels are processed through two extended buses 25a and 25b.

Referring to FIG. 2, the CMOS image sensor includes a pixel array 20 where red (R), green (G) and blue (B) pixels are arranged in an M N matrix form. A CDS part 22 including CDS circuits is provided at a lower side of the pixel array 20. In the CDS part 22, one CDS circuit per column is provided. An analog signal processor (ASP) 23 is provided at a right side of the pixel array 20 to process the analog signals outputted from the CDS part 22. A column driver 24 receives a column address to output column select signals CS0 to CS5, and a selecting part 26 selectively transfers output signals of the CDS circuits to a corresponding analog data bus in response to the column select signals CS0 to CS5.

The pixel array 20 includes a plurality of even rows and a plurality of odd rows. In the odd row, a G pixel is arranged in a first column, and a G pixel and an R pixel are alternately arranged. In the even row, a B pixel is arranged in a first column, and a B pixel and a G pixel are alternately arranged.

The output signals of the CDS part 22 are transferred through the analog data bus to the ASP 23. Unlike the prior art, the analog data bus is extended into a first analog data bus 25a and a second analog data bus 25b.

The output signals of the CDS circuits of the CDS part 22 are loaded on the first analog data bus 25a or the second analog data bus 25b by the selecting part 26, which is controlled by the select signal CS generated from the column driver 24. For example, when the even row is selected, signals of B pixels (signals which have passed through the CDS circuit) are transferred to the first analog data bus 25a, and signals of G pixels (signals which have passed through the CDS circuit) are transferred to the second analog data bus 25b. In addition, when the odd row is selected, signals of G pixels are transferred to the first analog data bus 25a, and signals of R pixels are transferred to the second analog data bus 25b.

Consequently, in reading the pixel data, if one row of the pixel array 20 is selected, the pixel data of the selected row are transferred to the corresponding CDS circuits of the CDS part 22 at once and at the same time. Then, under the control of the column driver 24, the output signals of the CDS circuits are sequentially transferred to the first or second analog data and then processed in the ASP 23.

In this embodiment, even though the number of the pixels increases and therefore the number of the CDS circuits increases, parasitic capacitance of the analog data bus can be reduced because the analog data bus is divided.

That is, load capacitance applied on the analog data bus is reduced as much as the number of the bus lines.

Accordingly, the processing speed of the analog signal transferred through the buses can be improved as much as the load reduction of the bus lines, and the entire processing bandwidth of the analog signal can be increased.

Second Embodiment

A CMOS image sensor in accordance with a second embodiment of the present invention uses one ASP and four analog data buses.

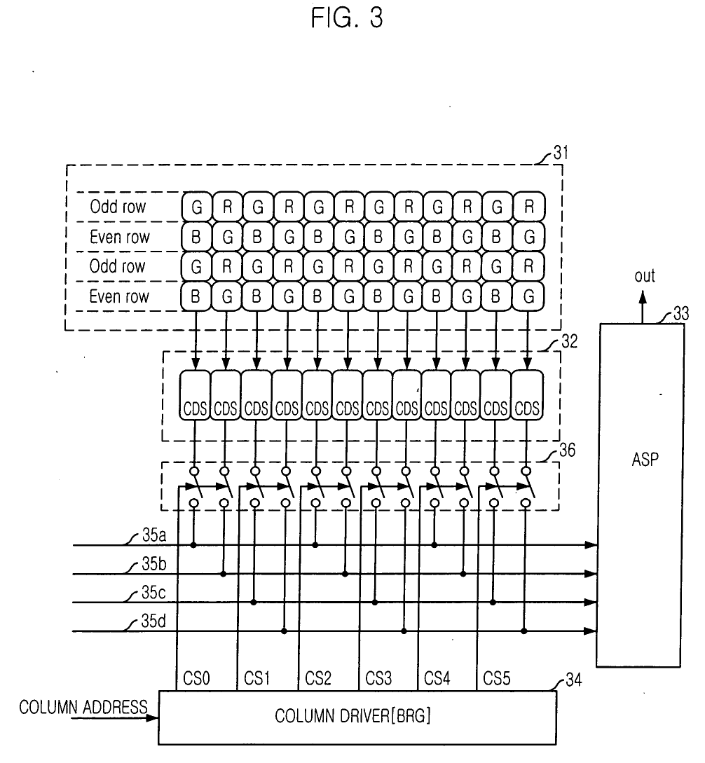

Referring to FIG. 3, the CMOS image sensor includes a pixel array 31 where red (R), green (G) and blue (B) pixels are arranged in an M N matrix form. A CDS part 32 including CDS circuits is provided at a lower side of the pixel array 31. In the CDS part 32, one CDS circuit per column is provided. An analog signal processor (ASP) 33 is provided at a right side of the pixel array 31 to process the analog signals outputted from the CDS part 32.

The output signals of the CDS part 32 are transferred through the analog data bus to the ASP 33. Unlike the prior art, the analog data bus is extended into first to fourth analog data buses 35a, 35b, 35c and 35d.

The output signals of the CDS circuits of the CDS part 32 are loaded on the first to fourth analog data buses 35a, 35b, 35c and 35d by a selecting part 36, which is controlled by a select signal CS generated from a column driver 34.

In reading a pixel data, if one row of the pixel array 31 is selected, the pixel data of the selected row are transferred to the corresponding CDS circuits of the CDS part 32 at once and at the same time. Then, under the control of the column driver 34, the output signals of the CDS circuits are sequentially transferred to the first to fourth analog data bus 35a, 35b, 35c and 35d and then processed in the ASP 33.

Third Embodiment

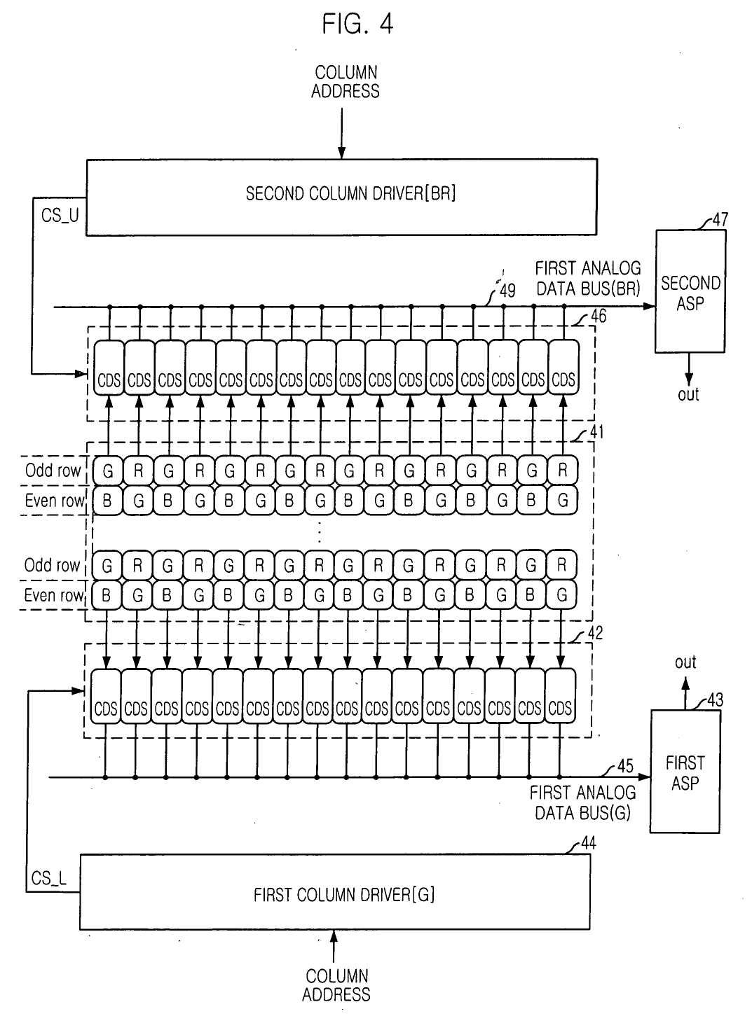

FIG. 4 is a diagram of a CMOS image sensor in accordance with a third embodiment of the present invention. An analog signal processing path for processing analog signals outputted from pixels of the pixel array is divided into two.

Referring to FIG. 4, the CMOS image sensor includes a pixel array 41 where red (R), green (G) and blue (B) pixels are arranged in an M N matrix form. CDS parts 42 and 46 including CDS circuits are provided at lower and upper sides of the pixel array 41. In the CDS parts 42 and 46, one CDS circuit per column is provided. An analog signal processor (ASP) 43 is provided at a right side of the pixel array 41 to process the analog signals outputted from the CDS part 42, and an ASP 47 is provided to process the analog signals outputted from the CDS part 46.

The pixel array 41 includes a plurality of even rows and a plurality of odd rows. In the even row, a G pixel is arranged in a first column, and a G pixel and an R pixel are alternately arranged. In the odd row, a B pixel is arranged in a first column, and a B pixel and a G pixel are alternately arranged.

The output signals of the CDS part 42 are transferred through the first analog data bus 45 to the ASP 43, and the output signals of the CDS part 46 are transferred through the second analog data bus 49 to the ASP 47.

The output signals of the CDS circuits of the CDS part 42 are loaded on the first analog data bus 45 in response to a select signal CS_L generated from a first column driver 44, and the output signals of the CDS circuits of the CDS part 46 are loaded on the second analog data bus 49 in response to a select signal CS_U generated from a second column driver 48. As shown in FIG. 4, under the control of the column drivers 44 and 48, the output signals of the CDS circuits of the CDS parts 42 and 46 are transferred to the analog data buses 45 and 49.

If one row of the pixel array 41 is selected, the pixel data of the selected row are transferred to the lower and upper CDS parts 42 and 46 of the corresponding columns. That is, the same pixel signals are transferred to the lower and upper CDS parts 42 and 46.

The first column driver 44 sequentially drives the CDS circuits of the columns corresponding to the G pixels among the lower CDS part 42, so that the output signals are loaded on the first analog data bus 45. These signals are processed by the corresponding ASP part 43. In addition, the second column driver 48 sequentially drives the CDS circuits of the columns corresponding to the B and R pixels among the upper CDS part 46, so that the output signals are loaded on the second analog data bus 49. These signals are processed by the corresponding ASP part 47.

Since the signals of the R and B pixels and the signals of the G pixels are processed through different paths, two signals can be processed at one clock at the same time.

Therefore, an analog system having two times bandwidth can be implemented.

Also, since two ASPs are provided, their role is reduced by half. Therefore, the ASP can use a low-speed system whose time margin is sufficient.

In addition, while the signals are processed through multi-paths, the color signals (that is, R, G and B signals) are processed through the same analog signal processing path. In this manner, the offset problem can be solved.

That is, the signals of the G pixels of the pixel array are decoded to be processed in the lower ASP 43 through the lower analog data bus 45, and the signals of the R and B pixels are decoded to be processed in the upper ASP 47 through the upper analog data bus 49. Accordingly, the offset between the same pixels can be minimized and the offset noise of the picture quality can be minimized.

Fourth Embodiment

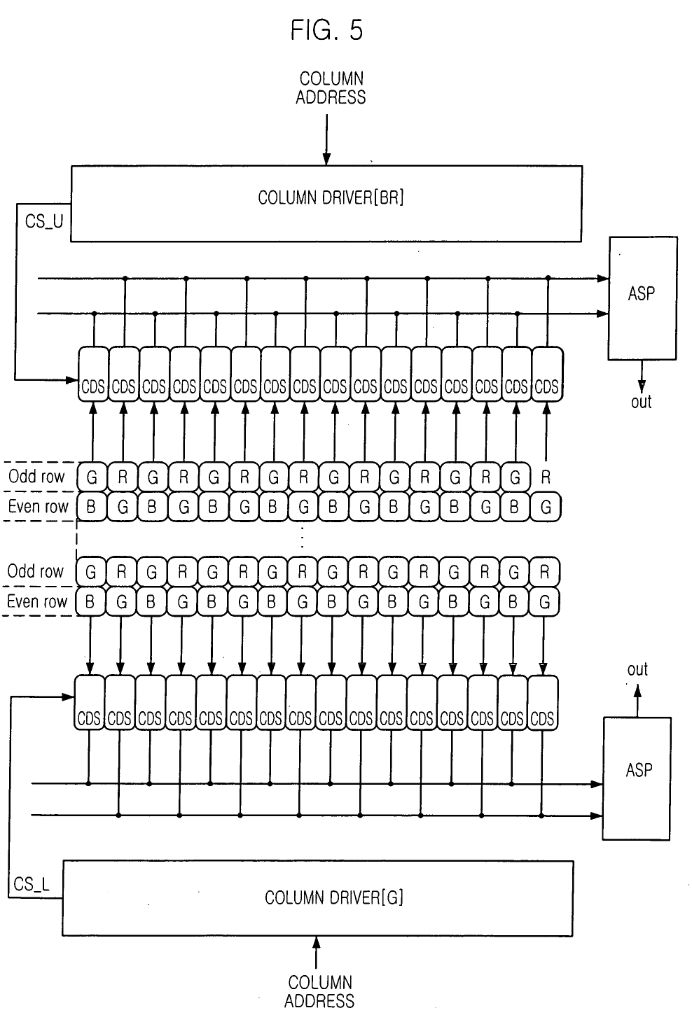

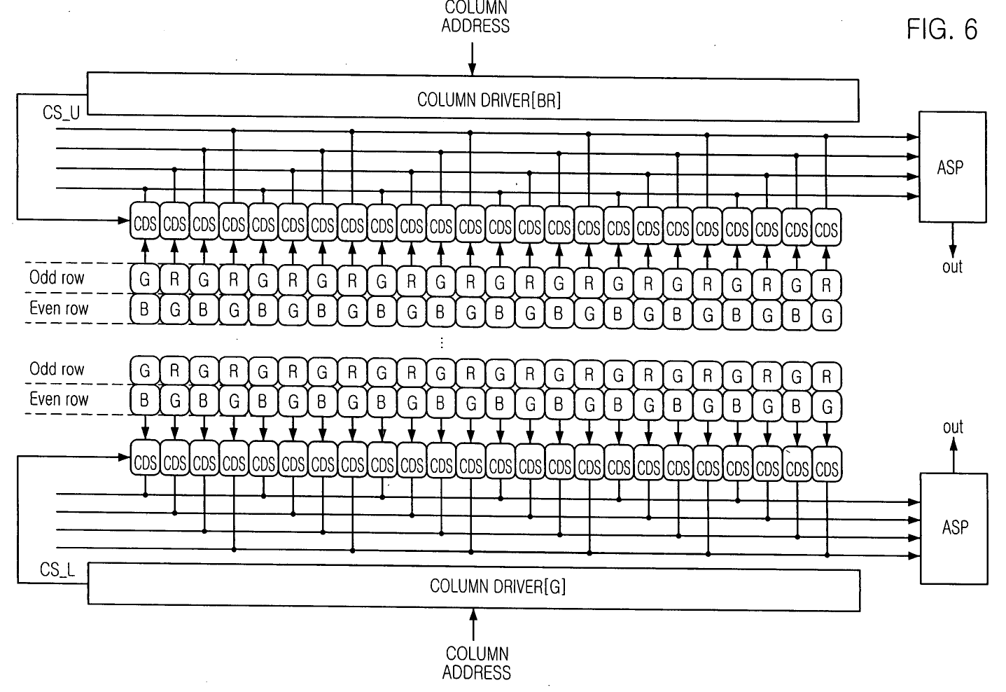

In this embodiment, the signal processing path is divided into two. A plurality of analog data buses can be applied to the respective analog signal processing paths. A fourth embodiment of the present invention will be described with reference to FIGS. 5 and 6.

Referring to FIG. 5, the analog signal processing path is divided into two and each path includes two analog data buses. At this point, the load capacitance of the analog data lines of each path can be reduced. Also, the signals can be processed at one clock and at the same time.

Referring to FIG. 6, the analog signal processing path is divided into two and each path includes four analog data buses. At this point, the load capacitance of the analog data buses of each path can be reduced much more. Also, the signals can be processed at one clock and at the same time.

In FIGS. 5 and 6, the signals of the G pixels are processed through the lower signal processing path, and the signals of the B and R pixels are processed through the upper signal processing path. In this manner, the offset between the same pixel signals can be minimized.

Embodiments of Decoding Method

Even when a low-speed system is used, the signals are processed through multi-paths and the color signals (that is, R, G and B signals) are decoded to be processed through the path of the same ASP. In this manner, the offset problem can be solved. Hereinafter, the embodiments of the decoding method will be described.

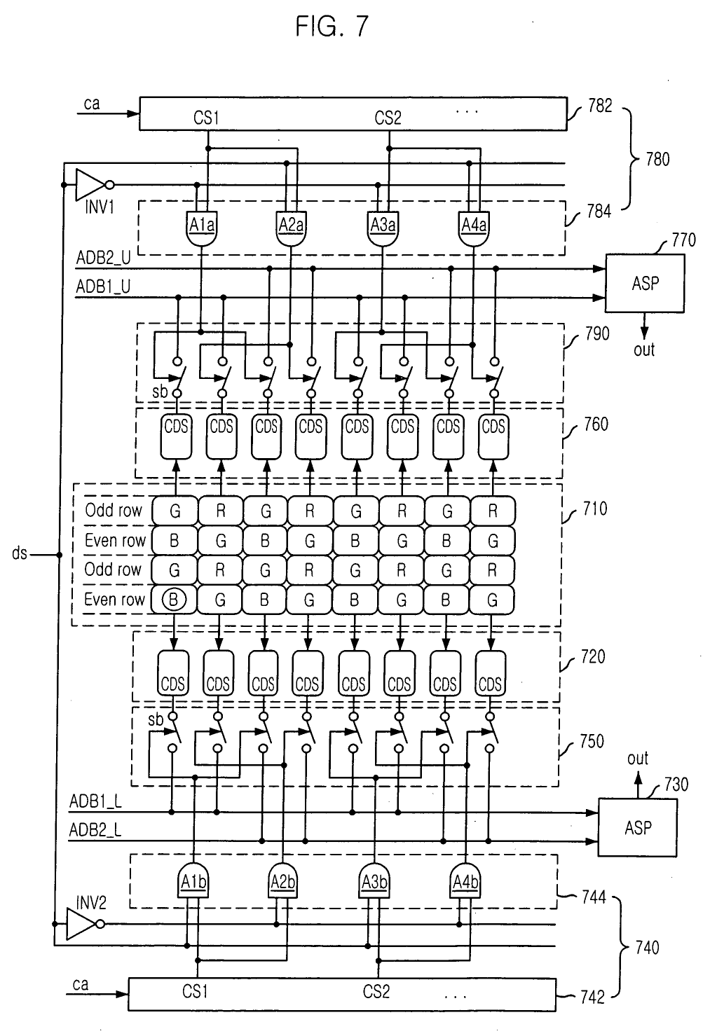

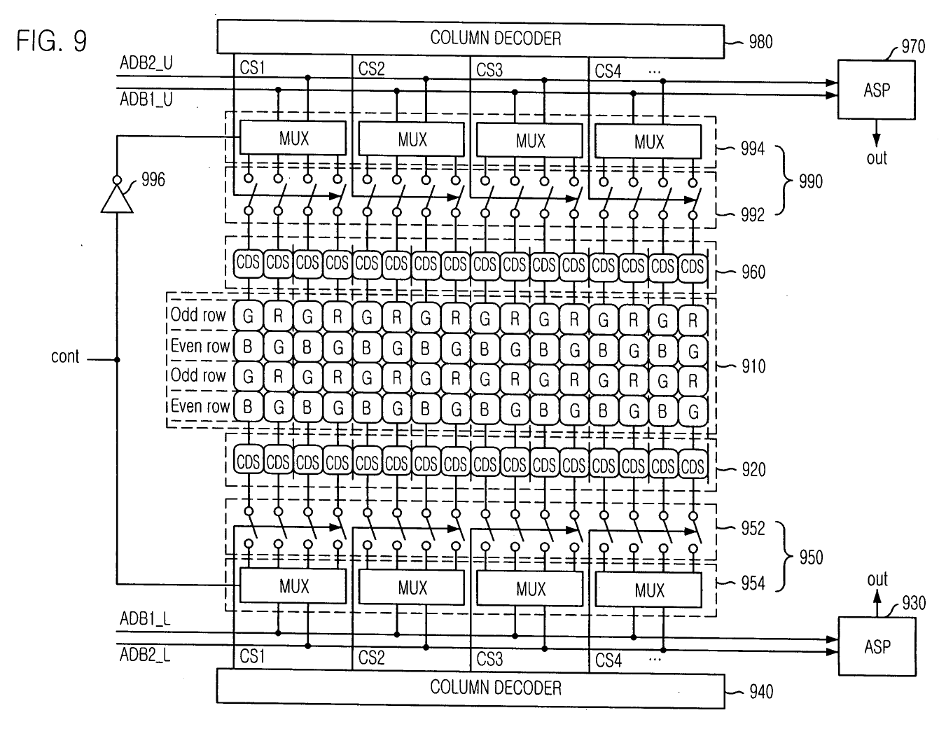

FIGS. 7 and 9 are diagrams illustrating the decoding schemes where the analog signal processing path is divided into two and each path includes two analog data buses. That is, the signals of the G pixels in the pixel array are decoded to be processed in the lower ASP through the lower analog data bus, and the signals of the R and B pixels are decoded to be processed in the upper ASP through the upper analog data bus.

Referring to FIG. 7, the CMOS image sensor includes a pixel array 710 where red (R), green (G) and blue (B) pixels are arranged in an M N matrix form. CDS parts 720 and 760 including CDS circuits are provided at lower and upper sides of the pixel array 710. In the CDS parts 720 and 760, one CDS circuit per column is provided. A lower ASP 730 is provided to process the analog signals outputted from the lower CDS part 720, and an upper ASP 770 is provided to process the analog signals outputted from the upper CDS part 760.

The pixel array 710 includes a plurality of even rows and a plurality of odd rows. In the even row, a G pixel is arranged in a first column, and a G pixel and an R pixel are alternately arranged. In the odd row, a B pixel is arranged in a first column, and a B pixel and a G pixel are alternately arranged.

The output signals of the lower CDS part 720 are transferred through first and second lower analog data buses ADB1_L and ADB2_L to the lower ASP 730 by a transfer unit, which is configured with a lower column driver 740 and a lower selector 750. The output signals of the upper CDS part 760 are transferred through first and second upper analog data buses ADB1_U and ADB2_U to the upper ASP 770 by a transfer unit, which is configured with an upper column driver 780 and an upper selector 790.

The lower selector 750 is configured with switching elements having one terminal connected to the CDS circuits of the lower CDS part 720 and the other terminal connected to the first lower analog data bus ADB1_U or the second lower analog data bus ADB2_U. Each switching element of the selector 750 is turned on/off under the control of the lower column driver 740.

The lower column driver 740 includes a column decoder 742 for receiving a column address ca to generate column select signals CS1, CS2, . . . , and an AND gate part 744 for receiving a driver select signal ds and column select signals CS1, CS2, . . . and controlling the switching elements of the select part 750.

Also, the upper selector 790 is configured with switching elements having one terminal connected to the CDS circuits of the upper CDS part 760 and the other terminal connected to the first upper analog data bus ADB1_U or the second upper analog data bus ADB2_U. Each switching element of the selector 790 is turned on/off under the control of the upper column driver 780.

The upper column driver 780 includes a column decoder 782 for receiving a column address ca to generate column select signals CS1, CS2, . . . , and an AND gate part 784 for receiving a driver select signal ds and column select signals CS1, CS2, . . . and controlling the switching elements of the select part 790.

The driver select signal ds is a logic signal having opposite logic values according to the selection of the even and odd rows. In this embodiment, the driver select signal has a logic “0” when the even row is selected, and the driver select signal has a logic “1” when the odd row is selected.

An overall operation of reading the pixel data will be described.

If one row of the pixel array 710 is selected, the output signals of the pixels of the selected row are transferred to the lower and upper CDS parts 720 and 760 at the same time.

That is, the same pixel signals are transferred to the lower and upper CDS parts 720 and 760.

Then, the column driver 740 sequentially drives the switching elements of the column corresponding to the G pixels, so that the signals are alternately loaded on the first or second analog data bus ADB1_L and ADB2_U. These signals are processed by the corresponding ASP 760.

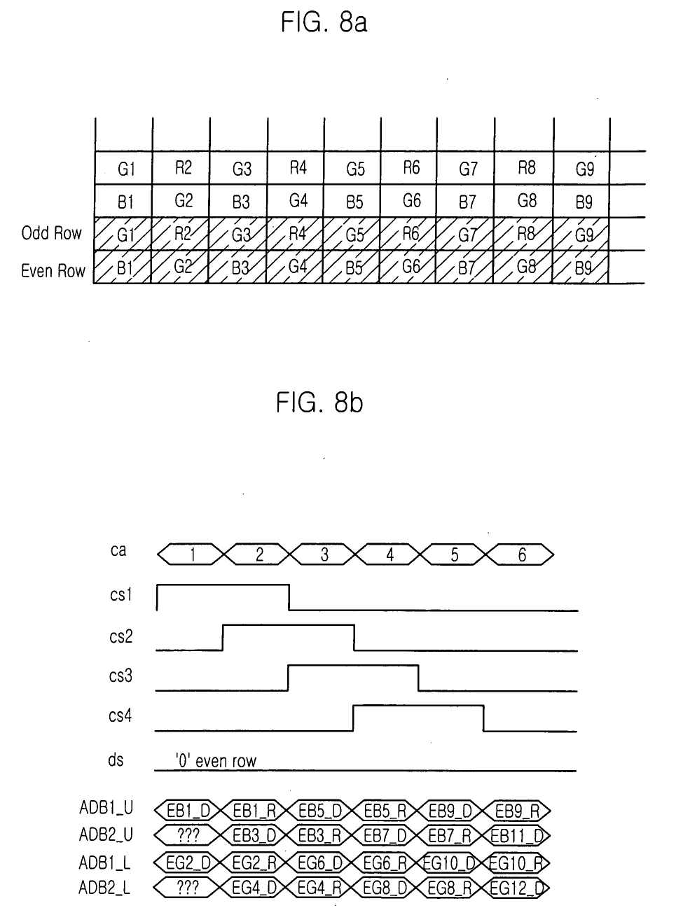

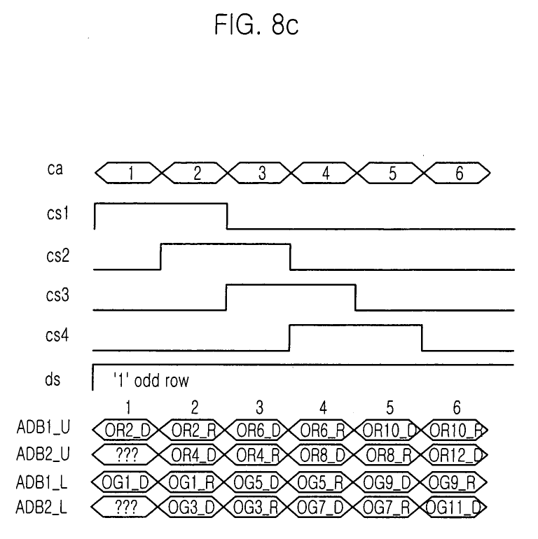

FIGS. 8A to 8C are timing diagrams of the pixel array.

The data processing operation of the CMOS image sensor shown in FIG. 7 will be described below.

FIG. 8A is a diagram of the pixel array, FIG. 8B is a timing diagram when the driver select signal ds is a logic “0” (that is, when the pixels of the even row are processed), and FIG. 8C is a timing diagram when the driver select signal ds is a logic “1” (that is, when the pixels of the odd row are processed).

In FIG. 8A, numerals are sequentially assigned so as to distinguish the pixels of the same color.

First, the operation of outputting the pixel data of the even row will be described with reference to FIG. 8A.

Although the data signal is outputted and then the reset signal is outputted, the reset signal can be first outputted.

When the column address ca is inputted to the column decoders 742 and 782 and four column select signals cs1 to cs4 are outputted, the driver select signal is a logic “0”.

Therefore, the complementary signal “dsb” is a logic “1”.

Thus, the AND gates receiving the complementary signal dsb output switching signals according to the column select signals cs1 to cs4. The AND gates that can have the switching signal of a logic “1” are A1a, A3a, A2b and A4b.

If the column select signal CS1 is activated, the data signal EB1_D and the reset signal EB1_R of the pixel B1 are consecutively loaded on the first upper analog data bus ADB1_U. The ASP 770 calculates a difference value between them and amplifies it. In this manner, data value of the pixel B1 is obtained. Then, the data signal EG2_D and the reset signal EG2_R of the pixel G2 are consecutively loaded on the first lower analog data bus ADB1_L. The ASP 730 calculates a difference value between them and amplifies it. In this manner, data value of the pixel G2 is obtained. When the reset signal EB1_R of the pixel B1 is loaded on the first upper analog data bus ADB1_U, the data signal EB3_D of the pixel B3 is loaded on the second upper analog data bus ADB2_U. When the reset signal EG2_R of the pixel G2 is loaded on the first lower analog data bus ADB1_L, the data signal EG4_D of the pixel G4 is loaded on the second lower analog data bus ADB2_L.

FIG. 8C is a timing chart illustrating the operation of outputting the data from the pixels of the odd pixel. Since this operation is similar to that of the even row, a detailed description thereof will be omitted.

As described above, the signals of the G pixels of the pixel array are decoded to be processed in the lower ASP through the first and second lower analog data buses, and the signals of the R and B pixels are decoded to be processed in the upper ASP through the first and second upper analog data buses. Accordingly, the offset between the same pixels can be minimized because the same colors are processed in the same ASP path.

FIG. 9 is a diagram illustrating a decoding scheme in accordance with another embodiment of the present invention.

Referring to FIG. 9, the CMOS image sensor includes a pixel array 910 where red (R), green (G) and blue (B) pixels are arranged in an M N matrix form. CDS parts 920 and 960 including CDS circuits are provided at lower and upper sides of the pixel array 910. In the CDS parts 920 and 960, one CDS circuit per column is provided. A lower ASP 930 is provided to process the analog signals outputted from the lower CDS part 920, and an upper ASP 970 is provided to process the analog signals outputted from the upper CDS part 960.

The pixel array 910 includes a plurality of even rows and a plurality of odd rows. In the even row, a G pixel is arranged in a first column, and a G pixel and an R pixel are alternately arranged. In the odd row, a B pixel is arranged in a first column, and a B pixel and a G pixel are alternately arranged.

The output signals of the lower CDS part 920 are transferred through first and second lower analog data buses ADB1_L and ADB2_L to the lower ASP 930 by a lower transfer unit 950. The output signals of the upper CDS part 960 are transferred through first and second upper analog data buses ADB1_U and ADB2_U to the upper ASP 970 by an upper transfer unit 990.

The lower selector 950 is configured with a switching part 952 and a multiplexer part 954. The switching part 952 has one terminal connected to the CDS circuits of the lower CDS part 920 and the other terminal connected to an input terminal of the corresponding multiplexer (MUX) of the multiplexer part 954. The switching part 952 is turned on/off under the control of the column select signal CS outputted from the column decoder 940.

The multiplexer of the multiplexer part 954 for the lower selector 950 can be implemented with a 4 2 multiplexer. The four input terminals are connected to the other terminal of the switching elements of the corresponding column, and one of the two output terminals is connected to the first lower analog data bus ADB1_L and the other is connected to the second lower analog data bus ADB2_L. Also, the multiplexer of the lower selector 950 transfers two of the four inputs to the first and second lower analog data buses ADB1_L and ADB2_L in response to a control signal cont. The control signal is a logic signal whose logic value is complementary according to the selection of the even and odd rows. In this embodiment, the control signal has a logic “0” when the even row is selected, and the control signal has a logic “1” when the odd row is selected.

The lower column decoder 940 receives the column address ca to generate the column select signals CS1, CS2.

The upper selector 990 is configured with a switching part 992 and a multiplexer part 994. The switching part 992 has one terminal connected to the CDS circuits of the upper CDS part 960 and the other terminal connected to an input terminal of the corresponding multiplexer (MUX) of the multiplexer part 994. The switching part 992 is turned on/off under the control of the column select signal CS outputted from the column decoder 980.

The multiplexer of the multiplexer part 994 for the upper selector 990 can be implemented with a 4 2 multiplexer. The four input terminals are connected to the other terminal of the switching elements of the corresponding column, and one of the two output terminals is connected to the first upper analog data bus ADB1_U and the other is connected to the second lower analog data bus ADB2_U. Also, the multiplexer of the upper selector 990 transfers two of the four inputs to the first and second upper analog data buses ADB1_U and ADB2_U in response to an inverted control signal.

The upper column decoder 990 receives the column address ca to generate the column select signals CS1, CS2.

Since an operation of the decoding method shown in FIG. 9 is the same as that of the FIG. 7, a detailed description thereof will be omitted.

According to the present invention, the analog signal is processed through the multi-paths, so that the signal processing speed is improved through the stable signal processing system. Also, while the signals are processed through the multi-paths, the signals of the same pixels of the pixel array are processed through the same path. In this manner, the offset between the same pixels can be minimized and thus the picture quality can be improved.

The present application contains subject matter related to Korean patent applications No. 2004-27596 and No. 2004-116655, filed in the Korean Patent Office on Apr. 21, 2004 and Dec. 30, 2004 respectively, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

1. A CMOS image sensor, comprising:
a pixel array having a plurality of first color pixels, a plurality of second color pixels and a plurality of third color pixels, which are arranged in matrix form;
a CDS (correlated double sampling) part having CDS circuits to receive output signals of the pixels, one CDS circuit per column being provided;
a plurality of analog data buses for receiving divided output signal of the CDS circuits; and
an ASP (analog signal processor) connected to the plurality of analog data buses.

2. The CMOS image sensor as recited in claim 1, further comprising:
a column driver for receiving a column address to generate a column select signal; and
a switching means for transferring the output signal of the CDS circuit to a corresponding analog data bus in response to the column select signal.

3. The CMOS image sensor as recited in claim 1, further comprising a transfer means for transferring an output signal of the CDS circuit, which corresponds to the pixels of the same color on the same row in the pixel array, to the same analog data bus.

4. The CMOS image sensor as recited in claim 3, wherein the transfer means includes:
a column driver for receiving a column address to generate a column select signal; and
a selector for selectively transferring the output signal of the CDS circuit to a corresponding analog data bus in response to the column select signal.

5. The CMOS image sensor as recited in claim 4, wherein the selector includes a plurality of switching elements connected between the CDS circuit and the analog data bus.

6. The CMOS image sensor as recited in claim 1, wherein the pixel array includes:
a plurality of even rows where a G pixel is arrange at a first column, and the G pixel and a R pixel are alternately arranged; and
a plurality of odd rows where a B pixel is arranged at a first column and the B pixel and the G pixel are alternately arranged.

7. A CMOS image sensor, comprising:
a pixel array having a plurality of R pixels, a plurality of G pixels and a plurality of B pixels that are arranged in matrix form;
a first analog signal processing path arranged in one side of the pixel array to process analog signals outputted from the G pixels of the pixel array; and
a second analog signal processing path arranged in the other side of the pixel array to process analog signals outputted from the B pixels or the R pixels of the pixel array.

8. The CMOS image sensor as recited in claim 7, wherein the first analog signal processing path includes:
a lower CDS part arranged in a lower side of the pixel array to receive output signals of all pixels of a selected row at a time, one CDS circuit per column being provided in the lower CDS part;
at least one lower analog data bus for receiving output signals of the CDS circuits corresponding to the G pixels; and
a lower ASP connected to the lower analog data bus.

9. The CMOS image sensor as recited in claim 8, wherein the second analog signal processing path includes:
an upper CDS part arranged in a lower side of the pixel array to receive output signals of all pixels of a selected row at a time, one CDS circuit per column being provided in the lower CDS part;
at least one upper analog data bus for receiving output signals of the CDS circuits corresponding to the R or B pixels; and
an upper ASP connected to the upper analog data bus.

10. The CMOS image sensor as recited in claim 8, wherein the first analog signal processing path further includes:
a first column driver configured to generate a first switching signal for transferring the output signals of the CDS circuit corresponding to the G pixels to the lower analog data bus; and
a lower selector for selectively transferring the output signals of the CDS circuits to the lower analog data bus in response to the first switching signal.

11. The CMOS image sensor as recited in claim 10, wherein the second analog signal processing path further includes:
a second column driver configured to generate a second switching signal for transferring the output signals of the CDS circuit corresponding to the R or B pixels to the upper analog data bus; and
an upper selector for selectively transferring the output signals of the CDS circuits to the upper analog data bus in response to the second switching signal.

12. The CMOS image sensor as recited in claim 10, wherein the lower selector includes a plurality of switching elements connected between the CDS circuit and the lower analog data bus.

13. The CMOS image sensor as recited in claim 11, wherein the upper selector includes a plurality of switching elements connected between the CDS circuit and the upper analog data bus.

14. The CMOS image sensor as recited in claim 10, wherein the first column driver includes:
a first column decoder for receiving a column address to generate a first column select signal; and
a first AND gate part for receiving a control signal having information on an odd or even row and the first column select signal to output a plurality of switching signal based on the column as the first switching signal.

15. The CMOS image sensor as recited in claim 11, wherein the second column driver includes:
a second column decoder for receiving a column address to generate a second column select signal; and
a second AND gate part for receiving a control signal having information on an odd or even row and the second column select signal to output a plurality of switching signal based on the column as the second switching signal.

16. The CMOS image sensor as recited in claim 8, wherein the first analog signal processing path further includes:
a first column decoder configured to generate a first column select signal for transferring the output signals of the CDS circuit corresponding to the G pixels to the lower analog data bus; and
a lower selector for selectively transferring the output signals of the CDS circuits to the lower analog data bus in response to the first column select signal.

17. The CMOS image sensor as recited in claim 9, wherein the second analog signal processing path further includes:
a second column decoder configured to generate a second column select signal for transferring the output signals of the CDS circuit corresponding to the R or B pixels to the upper analog data bus; and
an upper selector for selectively transferring the output signals of the CDS circuits to the upper analog data bus in response to the second column select signal.

18. The CMOS image sensor as recited in claim 16, wherein the lower selector includes:
a plurality of switching element for selectively transfer the output signals of the lower CDS part in response to the first column select signal; and
a plurality of multiplexers for selectively transferring at least one of the output signals of the lower CDS part in response to a control signal having information on an odd or even row.

19. The CMOS image sensor as recited in claim 17, wherein the upper selector includes:
a plurality of switching elements for selectively transfer the output signals of the upper CDS part in response to the second column select signal; and
a plurality of multiplexer for selectively transferring at least one of the output signals of the upper CDS part in response to a control signal having information on an odd or even row.

20. A CMOS image sensor, comprising:
a pixel array having a plurality of first color pixels, a plurality of second color pixels and a plurality of third color pixels, which are arranged in matrix form;
a lower CDS (correlated double sampling) part arranged in a lower side of the pixel array to receive output signals of the pixels, one CDS circuit per column being provided in the lower CDS part;
an upper CDS part arranged in an upper side of the pixel array to receive output signals of the pixels, one CDS circuit per column being provided in the upper CDS part;
a plurality of lower analog data buses for receiving divided output signal of the CDS circuits of the lower CDS part;
a plurality of upper analog data buses for receiving divided output signal of the CDS circuits of the upper CDS part;
a lower ASP (analog signal processor) connected to the plurality of lower analog data buses; and
an upper ASP connected to the plurality of upper analog data buses.

21. The CMOS image sensor as recited in claim 20, further comprising:
a first transfer means for dividing the output signals of the CDS circuits of the lower CDS part and transferring the divided output signals to the first and second lower analog data buses; and
a second transfer means for dividing the output signals of the CDS circuits of the lower CDS part and transferring the divided output signals to the first and second upper analog data buses.

22. The CMOS image sensor as recited in claim 21, wherein the pixel array includes a plurality of even rows where a G pixel is arrange at a first column, and the G pixel and a R pixel are alternately arranged; and
a plurality of odd rows where a B pixel is arranged at a first column and the B pixel and the G pixel are alternately arranged.

23. The CMOS image sensor as recited in claim 22, wherein the plurality of lower analog data buses receive the output signals of the CDS circuits corresponding to the G pixels among the CDS circuits of the lower CDS part through the first transfer means, and the plurality of upper analog data buses receive the output signals of the CDS circuits corresponding to the R or B pixels among the CDS circuits of the upper CDS part through the second transfer means.

24. The CMOS image sensor as recited in claim 22, wherein the plurality of lower analog data buses are configured with first and second lower analog data buses, and the plurality of upper analog data buses are configured with first and second upper analog data buses.

25. The CMOS image sensor as recited in claim 24, wherein the first transfer means includes:
a first column driver configured to generate a first switching signal for transferring the output signals of the CDS circuit corresponding to the G pixels to the first and second lower analog data buses; and
a lower selector for selectively transferring the output signals of the CDS circuits to the first and second lower analog data buses in response to the first switching signal, and
the second transfer means includes:
a second column driver configured to generate a second switching signal for transferring the output signals of the CDS circuit corresponding to the R or B pixels to the first and second upper analog data buses; and
an upper selector for selectively transferring the output signals of the CDS circuits to the first and second upper analog data buses in response to the second switching signal.

26. The CMOS image sensor as recited in claim 25, wherein the lower selector includes a plurality of first switching elements connected between the lower CDS part and the lower analog data bus, and the upper selector includes a plurality of second switching elements connected between the upper CDS part and the upper analog data bus.

27. The CMOS image sensor as recited in claim 25, wherein the first column driver includes:
a first column decoder for receiving a column address to generate a first column select signal; and
a first AND gate part for receiving a control signal having information on an odd or even row and the first column select signal to output a plurality of switching signal based on the column as the first switching signal, and the second column driver includes:
a second column decoder for receiving a column address to generate a second column select signal; and
a second AND gate part for receiving a control signal having information on an odd or even row and the second column select signal to output a plurality of switching signal based on the column as the second switching signal.

28. The CMOS image sensor as recited in claim 24, wherein the first transfer means includes:
a first column decoder configured to generate a first column select signal for transferring the output signals of the CDS circuits corresponding to the G pixels among the CDS circuits of the lower CDS part to the first and second lower analog data buses;
a plurality of first switching elements for selectively transferring the output signals of the lower CDS part in response to the first column select signal; and
a plurality of first multiplexers for selectively transferring the output signals of the lower CDS part to the first and second lower analog data buses in response to a control signal having information on an odd or even row, and
the second transfer means includes:
a second column decoder configured to generate a second column select signal for transferring the output signals of the CDS circuits corresponding to the G pixels among the CDS circuits of the upper CDS part to the first and second upper analog data buses;
a plurality of second switching elements for selectively transferring the output signals of the upper CDS part in response to the second column select signal; and
a plurality of second multiplexers for selectively transferring the output signals of the upper CDS part to the first and second upper analog data buses in response to a control signal having information on an odd or even row
